(19) United States
(12) Patent Application Publication
(10) Pub. No.: US 2012/0075065 A1
(43) Pub. Date: Mar. 29, 2012

(54) ELECTRICAL HOUSEHOLD APPLIANCE

(76) Inventor: Marius HILCKMANN, Witten (DE)

(21) Appl. No.: 12/969,970

(22) Filed: Dec. 16, 2010

(30) Foreign Application Priority Data
Dec. 17, 2009 (DE) 102009059181.8

(51) Int. Cl. G08B 5/22

(52) U.S. Cl. 340/6.1

(57) ABSTRACT

In order to provide an electrical household appliance comprising control elements for the selection and/or activation of a control function as well as preferably comprising a display for indicating functions selected, to be selected and/or activated, which permits a simple and safe operation of the device by the user even where space is limited, it is proposed that the control elements are part of a handling unit to be fixed detachably at the device, the handling unit being connected in a communicating fashion by wires or preferably wireless with an electrical or electronic control unit remaining at the device and forming a structural unit therewith.

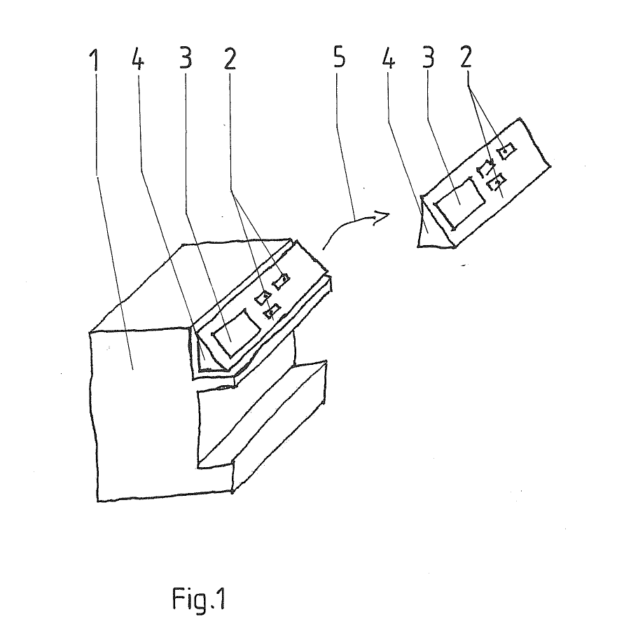

### FIELD OF THE INVENTION

The invention concerns an electrical household appliance, for instance a device for preparing hot beverages, comprising control elements for the selection and/or activation of a control function as well as preferably comprising a display for indicating functions selected, to be selected or activated. Toasters, egg boilers, mixers or other small electrical appliances are also covered by the term household appliances.

### BACKGROUND OF THE INVENTION

Devices of this species are known in the art. In conventional devices, the control functions and the program functions are mechanically or electronically entered by the user. When controlling devices supported by microcomputers, communication with the microcomputer is usually performed by digital inputs or outputs. For the selection and activation of a control function or of a program function, usually several keys or switches or also selector switches are used. The adjusted or selected control function or the activated function is often shown on a display, which may for instance be an LED display or also an LC display.

Usually, the corresponding control unit, if applicable together with the display, is integrated in the housing of the device and firmly connected with the device. Thereby, the accessibility and the visual inspection is often difficult to perform, in particular when there are larger devices or when these are located or firmly built-in at a limited space, for instance in a kitchen or the like.

### OBJECT OF THE INVENTION

Based on this prior art, it is the object of the invention to provide a device of the mentioned species, which permits a simple and safe operation of the device by the user even where space is limited.

### SUMMARY OF THE INVENTION

For achieving this object, it is proposed that the control elements are part of a handling unit to be fixed detachably at the device, the handling unit being connected in a communicating fashion by wires or preferably wireless with an electrical or electronic control unit remaining at the device and forming a structural unit therewith.

In a first embodiment, the control elements are part of a handling unit, so to speak in the form of a remote control, which communicates by wires or preferably wireless with a control unit remaining at the device and formed unitarily therewith. If the device is located in a limited installation space, the user can remove the handling unit from the device and position it at a suitable place or hold it in his hand, in order to perform the operation in a simple way.

In addition, it may be provided that the handling unit also comprises the display.

Then the handling unit also comprises the display, so that the user can perform not only the controls, with the handling unit being removed from the device, but also has a better view on the display.

A alternative solution of the object is that in addition to the control elements firmly arranged at the device and/or to the display, a separate handling unit is provided that is connected in a communicating fashion by wires or preferably wireless with the control unit of the device, and that comprises at least some control elements and/or a display.

According to this embodiment, the device is in principle constructed in a conventional way, I.E. comprises firmly arranged control elements and if applicable a display.

In addition, a separate handling unit is provided that communicates by wires or also wireless with the control unit of the device. The user is therefore free either to use the control elements at the device themselves and view the display arranged there, or in tight spaces, to perform the operations by the additional handling unit and to take views at a different place at a distance from the device.

For all solutions, it is preferably provided that the wireless connection is formed by a radio link.

It may also be provided that several devices or the control elements thereof are networked, so that by one handling unit several or all devices can be controlled.

### BRIEF DESCRIPTION OF THE DRAWING

A schematic embodiment of the invention is shown in the drawing and is described in more detail in the following.

### SPECIFIC DESCRIPTION

There is shown in the single FIGURE a view of the device according to the invention.

In the drawing, a device for preparing hot beverages generally designated by 1 is shown. Such a device has the conventional construction that is not explained in more detail in the drawing and in the description, since it is well known. The device comprises control elements 2 for the selection and/or activation of a control function, as well as a display 3 for instance for indication of the state of the selected activation and/or function.

According to the invention, the control elements 2 and preferably also the display 3 are part of a handling unit 4 detachably fixed at the device, in the embodiment the handling unit communicating wireless with an electrical or electronic control unit remaining at the device 1, forming a structural unit therewith. This embodiment permits the user to operate the device either with the handling unit 4 arranged at the device 1 or to remove it according to the movement arrow 5 from the device 1 and to operate it at a location remote from the device 1.

Instead of this embodiment, it is also possible that at the device, on the one hand, control elements 2 and/or a display 3 are firmly arranged, in addition a handling unit 4 being provided that communicates by wires or wireless with the control unit of the device 1. This embodiment, too, permits that the user either operates and views directly at the device 1, or uses the separate handling unit 4 with corresponding control elements 2 and/or a corresponding display 3 at a separate location.

The invention is not limited to this embodiment, but is in many ways variable within the scope of the disclosure.

All novel individual or combined features disclosed in the description and/or drawing are deemed essential for the is invention.

I claim:

1. An electrical household appliance, for instance a device for preparing hot beverages, comprising control elements for the selection and/or activation of a control function as well as preferably comprising a display for indicating functions selected, to be selected and/or activated, wherein the control elements are part of a handling unit to be fixed detachably at the device, the handling unit being connected in a communicating fashion by wires or preferably wireless with an electrical or electronic control unit remaining at the device and forming a structural unit therewith.

2. The device according to claim 1, wherein the handling unit also comprises the display.

3. The device according to the preamble of claim 1, wherein in addition to the control elements firmly arranged at the device and/or to the display, a separate handling unit is provided that is connected in a communicating fashion by wires or preferably wireless with the control unit of device, and that comprises at least some control elements and/or a display.

4. The device according to claim 1, wherein the wireless connection is a radio link.
